(19) United States
(12) Patent Application Publication
(10) Pub. No.: US 2026/0095038 A1
(43) Pub. Date: Apr. 2, 2026

(54) REDUNDANT POWER SYSTEM, PROTECTION CIRCUIT THEREOF, AND ERROR DETECTION METHOD THEREOF

(71) Applicant: ACBEL POLYTECH INC., New Taipei City (TW)

(72) Inventor: Hsuan-An CHEN, New Taipei City (TW)

(73) Assignee: ACBEL POLYTECH INC., New Taipei City (TW)

(21) Appl. No.: 18/901,788

(22) Filed: Sep. 30, 2024

(51) Int. Cl. H02H 3/16; H02J 9/06

(52) U.S. Cl. CPC H02H 3/16; H02J 9/061

(57) ABSTRACT

A power redundant system and its protection circuit is configured to have a second circuit unit receiving electricity from a first circuit unit through a power loop. An isolation switch is connected in series with the power loop. An electrical detection unit connects to the power loop to detect electrical changes and accordingly output a voltage signal to a processing unit. A first switch unit is connected in parallel to the first circuit unit and the second circuit unit. When the isolation switch is controlled to be turned off, the processing unit controls a conduction state of the first switch unit for allowing the voltage signal to change in response to the conduction state of the first switch unit. When the processing unit determines that a signal feature of the voltage signal mismatches with an isolation characteristic, the isolation switch is determined to be abnormal with an electrical leakage.

### BACKGROUND OF THE INVENTION

### 1. Field of the Invention

The present invention relates to a power system, a circuit of the power system, and an error detection method for the power system. More particularly, the present invention relates to a redundant power system, a protection circuit thereof, and an error detection method thereof.

### 2. Description of the Related Art

For a power supply with a power supply circuit, the power supply should receive and output electricity stably to ensure a steady supply of electric power to a load that is connected to the power supply. To receive and output electricity stably, for instance, means that the power supply does not have any electrical leakage when receiving or outputting electricity.

With reference to FIG. 6, for example, under a current redundant power system, a plurality of power supplies PS1, PS2, and PS3 all provide power to a load LD. The power supplies PS1, PS2, and PS3 are connected in series to the load LD, and a plurality of switches SW1, SW2, and SW3 are correspondingly connected between the load and the power supplies PS1, PS2, and PS3. The switches SW1, SW2, and SW3 may be metal-oxide-semiconductor field-effect transistors (MOSFETs), and the switches SW1, SW2, and SW3 are correspondingly controlled by a plurality of controllers C1, C2, and C3. In other words, the switch SW1 is controlled by the controller C1 for controlling whether the power supply PS1 should conduct to supply electricity to the load LD, and the switch SW2 is controlled by the controller C2 for controlling whether the power supply PS2 should conduct to supply electricity to the load LD, etc.

When one of the power supplies needs to disconnect from the load LD, for example when the power supply PS1 needs to disconnect from the load LD, in order to prevent a drop in voltage value received by the load LD, the rest of power supplies PS2 and PS3 would need to continuously supply power to the load LD for maintaining the voltage value supplied to the load LD. As such, the controllers C2 and C3 need to control the switches SW2 and SW3 to continuously conduct electricity, thus allowing the power supplies PS2 and PS3 to continuously supply power to the load LD. Furthermore, to prevent the continuously powered power supplies PS2 and PS3 from backfeeding power to the power supply PS1 being inserted or removed, which may cause leakage to the power supply PS1, the controller C1 turns off the switch SW1 to disconnect the circuit between the power supply PS1 and the load LD. The above describes a redundant power supply architecture with an isolation switch (i.e., ORing MOS).

However, the current redundant power system, with a chip CP of model FDMS7650, is unable to verify whether each of the MOSFETs within the chip CP is functional or broken. In other words, the current redundant power system is unable to verify whether the switches SW1, SW2, and SW3 are expectedly controlled by the controllers C1, C2, and C3. For example, if the switch SW1 failed and the controller C1 is unable to control the switch SW1 to stop conducting, the electric power supplied by the power supplies PS2 and PS3 will surge into the power supply SP1 at the moment it stops supplying power before being inserted or removed. This could potentially cause damage to the power supply SP1 due to the inrush of power and, simultaneously, cause an abnormal power supply to the load LD due to a sudden drop in voltage. The load LD, experiencing abnormal power reception, is highly likely to activate its protection mechanism and shut down, resulting in operational disruptions for the end user.

In order to prevent the above-mentioned problem, wherein an electrical leakage occurs as the reverse current rush into the power supply PS1, a circuit level improvement is needed, to ensure that a power supply is free from electrical leakages when outputting or receiving electricity.

### SUMMARY OF THE INVENTION

To overcome the aforementioned problems, the present disclosure provides a redundant power system, a protection circuit thereof, and an error detection method thereof. The present disclosure is able to detect electrical changes of electricity transportation between two circuits, thus providing an analysis of whether an electrical leakage occurred when a power supply is transporting electricity.

The redundant power system of the present disclosure includes: a first circuit unit; a second circuit unit, electrically connected to the first circuit unit to form a power loop, wherein the second circuit unit receives a power provided by the first circuit unit via the power loop; an isolation switch, connected in series with the power loop; an electrical detection unit, electrically connected to the power loop for detecting an electrical change on the power loop and accordingly outputting a voltage signal; a first switch unit, connected in parallel with the first circuit unit and the second circuit unit; and a processing unit, electrically connected to the electrical detection unit and the first switch unit for determining whether the isolation switch is abnormal. When the isolation switch is controlled to be turned off, the processing unit controls a conduction state of the first switch unit so that the voltage signal changes in response to a conduction state of the first switch unit. The processing unit determines whether a signal feature of the voltage signal matches with an isolation characteristic, and when the signal feature mismatches with the isolation characteristic, the isolation switch is determined to be abnormal.

The protection circuit of the redundant power system of the present disclosure includes: a power loop, configured to electrically connect a first circuit unit and a second circuit unit, wherein the second circuit unit receives a power provided by the first circuit unit via the power loop; an isolation switch, connected in series with the power loop; an electrical detection unit, electrically connected to the power loop for detecting an electrical change on the power loop and accordingly outputting a voltage signal; a first switch unit, connected in parallel with the first circuit unit and the second circuit unit; and a processing unit, electrically connected to the electrical detection unit and the first switch unit for determining whether the isolation switch is abnormal. When the isolation switch is controlled to be turned off, the processing unit controls a conduction state of the first switch unit, thus allowing the voltage signal to change in response to a conduction state of the first switch unit. The processing unit determines whether a signal feature of the voltage signal matches with an isolation characteristic, and when the signal feature mismatches with the isolation characteristic, the isolation switch is determined to be abnormal.

The error detection method of the present disclosure is executed by a processing unit of the redundant power system, and the error detection method of the present disclosure includes the following steps: controlling a conduction state of a first switch unit, and thus allowing a voltage signal received from an electrical detection unit to change in response to a conduction state of the first switch unit; determining whether a signal feature of the voltage signal matches with an isolation characteristic; and when the signal feature mismatches with the isolation characteristic, the isolation switch is determined to be abnormal.

By controlling the conduction state of the first switch unit when the isolation switch is turned off and by receiving the voltage signal from the electrical detection unit to determine whether the signal feature of the voltage signal matches with the isolation characteristic, the processing unit of the present disclosure is able to monitor the electrical change in the electrical power that is being delivered between the first circuit unit and the second circuit unit. When the signal feature mismatches with the isolation characteristic, the processing unit of the present disclosure determines that the isolation switch is abnormal, and thus the processing unit can identify that power delivery between the first circuit unit and the second circuit unit is abnormal with an electrical leakage.

As relating to a redundant power system, the present disclosure is able to assist in pre-testing whether the electronic components within the redundant power system are functioning correctly, thereby helping to prevent power supply abnormalities when the redundant power system is put into actual use. In other words, when the present disclosure assists in a pre-test and discovers that the power delivery between the first circuit unit and the second circuit unit is abnormal with an electrical leakage, a user of the present disclosure is then able to conduct maintenance to a circuit of the redundant power system, such as replacing malfunctioning electronic components in the circuit, before the redundant power system is put into actual usage. As a result, after the redundant power system is put into actual usage, and when the first circuit unit is hot swapping (hot un-plugging) away from the second circuit unit, the present disclosure is able to prevent damaging current from leaking and rushing into the first circuit unit due to a malfunction of an electronic component, thus preventing the first circuit unit from being damaged.

### BRIEF DESCRIPTION OF THE DRAWINGS

FIG. 1 is a circuit diagram of a redundant power system in a first embodiment of the present disclosure.

FIG. 2 is a circuit diagram of a protection circuit of the redundant power system in the first embodiment of the present disclosure.

FIG. 3 is a circuit diagram of the redundant power system in a second embodiment of the present disclosure.

FIG. 4 is a flow chart of an error detection method of the redundant power system of the present disclosure.

FIG. 5 is a flow chart of the error detection method in an embodiment of the present disclosure.

FIG. 6 is another flow chart of the error detection method in the embodiment of the present disclosure.

FIG. 7 is a circuit diagram of a current redundant power system.

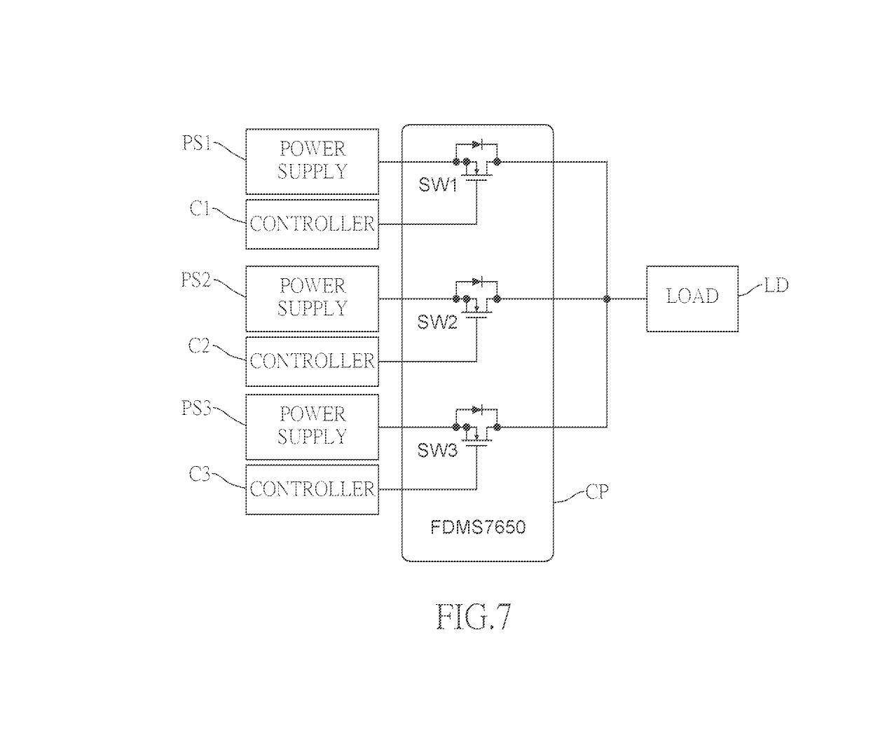

### DETAILED DESCRIPTION OF THE INVENTION

The present disclosure provides a redundant power system, a protection circuit thereof, and an error detection method thereof.

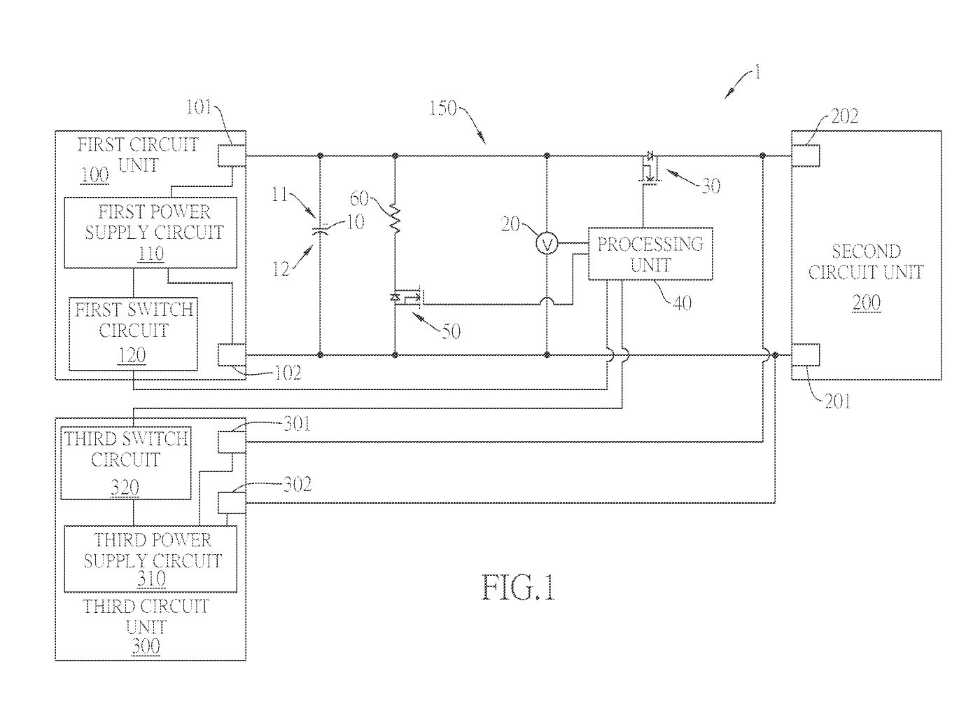

With reference to FIG. 1, a redundant power system 1 of the present disclosure includes an electrical detection unit 20, an isolation switch 30, a processing unit 40, a first switch unit 50, a first circuit unit 100, and a second circuit unit 200. In a preferred embodiment, the redundant power system 1 also includes a capacitor 10.

The first circuit unit 100 and the second circuit unit 200 are electrically connected together to form a power loop 150. The second circuit unit 200 receives a power provided by the first circuit unit 100 via the power loop 150. The isolation switch 30 is connected in series with the power loop 150, and the first switch unit 50 is connected in parallel with the first circuit unit 100 and the second circuit unit 200. The electrical detection unit 20 is electrically connected to the power loop 150 for detecting an electrical change on the power loop 150, and the electrical detection unit 20 accordingly outputs a voltage signal to the processing unit 40. The processing unit 40 is electrically connected to the electrical detection unit 20 and the first switch unit 50, and the processing unit 40 determines whether the isolation switch 30 is abnormal. When the isolation switch 30 is controlled to be turned off, for example, when the processing unit 40 controls the isolation switch 30 to cut off electricity, the processing unit 40 further controls a conduction state of the first switch unit 50 so that the voltage signal changes in response to a conduction state of the first switch unit 50. The processing unit 40 determines whether a signal feature of the voltage signal matches with an isolation characteristic. When the signal feature mismatches with the isolation characteristic, the isolation switch 30 is determined by the processing unit 40 to be abnormal.

More particularly, the first circuit unit 100 includes a first port 101 and a second port 102, and a second circuit unit 200 includes a third port 201 and a fourth port 202. The first port 101 of the first circuit unit 100 is electrically connected to the fourth port 202 of the second circuit unit 200. The third port 201 of the second circuit unit 200 is electrically connected to the second port 102 of the first circuit unit 100. The key features of the present disclosure lie in the electronic components that are located between the first port 101 and the second port 102 of the first circuit unit 100 and between the third port 201 and the fourth port 202 of the second circuit unit 200. In other words, the key features of the present disclosure are the capacitor 10, the electrical detection unit 20, the isolation switch 30, and the processing unit 40 that are disposed in the power loop 150.

The capacitor 10 includes a first side 11 and a second side 12, and the second side 12 is opposite to the first side 11. The first side 11 of the capacitor 10 is electrically connected to the first port 101 of the first circuit unit 100 and the fourth port 202 of the second circuit unit 200. The second side 12 of the capacitor 10 is electrically connected to the third port 201 of the second circuit unit 200 and the second port 102 of the first circuit unit 100.

The electrical detection unit 20 is electrically connected between the first side 11 and the second side 12 of the capacitor 10. The electrical detection unit 20 detects a voltage difference between the first side 11 and the second side 12 and accordingly generates and outputs a voltage signal to the processing unit 40.

The isolation switch 30 includes a first connection port, a second connection port, and a first control port. The first connection port is electrically connected to the first port 101 of the first circuit unit 100. The second connection port is electrically connected to the fourth port 202 of the second circuit unit 200.

The processing unit 40 is respectively electrically connected to the first control port of the isolation switch 30 and the electrical detection unit 20. The processing unit 40 receives the voltage signal outputted by the electrical detection unit 20, and the processing unit 40 determines the voltage difference measured by the electrical detection unit 20 according to the received voltage signal.

For sampling how electricity is used between the first circuit unit 100 and the second circuit unit 200 while keeping the electronic components working and functional between the first circuit unit 100 and the second circuit unit 200, the processing unit 40, in the present embodiment, generates and outputs a control signal to the first control port of the isolation switch 30 for changing a conduction state between the first connection port and the second connection port of the isolation switch 30, i.e. for controlling the isolation switch 30 to insulate instead of conducting electricity. Furthermore, the processing unit 40 determines whether the conduction state of the isolation switch 30 changes in response to (has an effect on) the voltage differences measured by the electrical detection unit 20, or in other words, the processing unit 40 determines whether a change in the conduction state of the isolation switch 30 changes how the capacitor 10 holds the voltage difference across the first side 11 and the second side 12. For this reason, when the processing unit 40 generates and outputs the control signal to the first control port for changing the conduction state between the first connection port and the second connection port of the isolation switch 30, i.e. for insulating the first side 11 and the second side 12 of the isolation switch 30, the processing unit 40 determines whether the signal feature of the voltage signal matches with the isolation characteristic. In the present embodiment, the isolation characteristic relates to a signal feature of when the capacitor 10 is discharging, and therefore, under normal circumstances, the signal feature of the voltage signal should match with the signal feature of having voltage changes when the capacitor 10 is discharging. In short, in the present embodiment, the processing unit 40 determines whether the voltage signal is having voltage changes.

When the processing unit 40 determines that the voltage signal does not change, the processing unit 40 thus determines that an electrical leakage occurred between the first circuit unit 100 and the second circuit unit 200 due to an abnormality of the isolation switch 30, and so the processing unit 40, recognizing this abnormality, accordingly generates and outputs a power supply abnormal signal to signify this situation. When the processing unit 40 determines that the voltage signal is having voltage changes, the processing unit 40 thus determines that between the first circuit unit 100 and the second circuit unit 200 is electrical leakage free due to the isolation switch 30 functioning normally, and so the processing unit 40 refrains from generating the power supply abnormal signal. In short, when the processing unit 40 determines that the voltage signal is having voltage changes, the capacitor 10 is discharging. When the processing unit 40 determines that the voltage signal does not change, the capacitor 10 fails to discharge. This outlines how the processing unit 40 of the present disclosure is able to determine if an abnormality of electrical leakage occurred between the first circuit unit 100 and the second circuit unit 200. By determining whether the power supply abnormal signal is outputted, a user of the present disclosure is able to understand whether the electrical leakage occurred between the first circuit unit 100 and the second circuit unit 200. For better demonstrating how the present disclosure is able to determine the electrical leakage between the first circuit unit 100 and the second circuit unit 200, please refer to a first embodiment of the present disclosure as shown in FIG. 1.

In the first embodiment, the redundant power system 1 of the present disclosure is using Oring MOS. The first circuit unit 100 is a power providing circuit for supplying power, such as belonging to a power supply. The second circuit unit 200 is a load for accepting the power supplied by the first circuit unit 100. For example, the second circuit unit 200 belongs to a machine or an electrical equipment that requires uninterruptible power supply (UPS). To ensure that the second circuit unit 200 continuously receives uninterrupted supply of stable voltage, the redundant power system further includes several power supplying circuits. For example, a third circuit unit 300 may belong to a power supply identical to the first circuit unit 100. The third circuit unit 300 includes a fifth port 301 and a sixth port 302. The fifth port 301 of the third circuit unit 300 is electrically connected to the fourth port 202 of the second circuit unit 200, and the third port 201 of the second circuit unit 200 is electrically connected to the sixth port 302 of the third circuit unit 300.

Furthermore, the first circuit unit 100 includes a first power supply circuit 110 and a first switch circuit 120. The third circuit unit 300 includes a third power supply circuit 310 and a third switch circuit 320.

The first power supply circuit 110 is electrically connected to the first port 101 and the second port 102, and the first switch circuit 120 is electrically connected to the first power supply circuit 110 and the processing unit 40. The third power supply circuit 310 is electrically connected to the fifth port 301 and the sixth port 302, and the third switch circuit 320 is electrically connected to the third power supply circuit 310 and the processing unit 40. The processing unit 40 controls the first switch circuit 120 to initiate the first power supply circuit 110, and the processing unit 40 further controls the third switch circuit 320 to initiate the third power supply circuit 310. This allows the first power supply circuit 110 to output a voltage from the first port 101 to the second circuit unit 200, and also allows the third power supply circuit 310 to output the same voltage from the fifth port 301 to the second circuit unit 200.

In the first embodiment, the present disclosure further includes a first resistor 60, and also the first switch unit 50 includes a third connection port, a fourth connection port, and a second control port. The third connection port, the fourth connection port, and the first resistor 60 are connected in series between the first side 11 and a second side 12 of the capacitor 10. The processing unit 40 is electrically connected to the second control port of the first switch unit 50.

In the present embodiment, the isolation switch 30 and the first switch unit 50 are both N-type Metal-Oxide-Semiconductor Field-Effect Transistors (N-type MOSFET, or simply NMOS). For the isolation switch 30, the first connection port is a source electrode, the second connection port is a drain electrode, and the first control port is a gate electrode. For the first switch unit 50, the third connection port is a source electrode, the fourth connection is a drain electrode, and the second control port is a gate electrode.

In a preferred embodiment, the first circuit unit 100 and the third circuit unit 300 respectively output direct-current (DC) voltage from the first port 101 and the fifth port 301 to the fourth port 202 of the second circuit unit 200. The second port 102 of the first circuit unit 100, the third port 201 of the second circuit unit 200, and the sixth port 302 of the third circuit unit 300 are all connected to a common ground.

Before the processing unit 40 generates and outputs the control signal to the first control port of the isolation switch 30 for changing the conduction state of the isolation switch 30, the processing unit 40 first: controls the first control port of the isolation switch 30 to turn on the first connection port and the second connection port, controls the second control port of the first switch unit 50 to turn off (to cut off) the third connection port and the fourth connection port, controls the first circuit unit 100 to provide electricity from the first port 101 to the fourth port 202 of the second circuit unit 200, and controls the third circuit unit 300 to further provide electricity from the fifth port 301 to the fourth port 202 of the second circuit unit 200. In short, before the processing unit 40 changes the conduction state of the isolation switch 30, a plurality of power supplies, such as the first circuit unit 100 and the third circuit unit 300, are supplying power to the load, such as the second circuit unit 200. At the same time, since the first switch unit 50 is insulating rather than conducting, the capacitor 10 is able to be charged efficiently.

When the capacitor 10 is fully charged, the present disclosure thus reaches a condition most suitable for monitoring whether the capacitor 10 may successfully discharge with a change in the conduction state of the isolation switch 30. At this moment, the processing unit 40 may then generate and output the control signal to the first control port of the isolation switch 30 for changing the conduction state of the isolation switch 30.

When the processing unit 40 outputs the control signal to the first control port of the isolation switch 30, the processing unit 40 simultaneously: controls the first circuit unit 100 to stop outputting power from the first port 101, controls the third circuit unit 300 to continuously output power from the fifth port 301, controls the first control port to be turned off, or to cut off between the first connection port and the second connection port, and controls the second control port to be turned on, or to conduct, the third connection port and the fourth connection port. In this case, the present disclosure is able to supply power to the second circuit unit 200 uninterruptedly from the third circuit unit 300, while allowing the first circuit unit to be hot swapped.

To avoid the power outputted by the third circuit unit 300 from rushing into the first circuit unit 100 when the first circuit unit 100 is hot swapping, in other words, to avoid the first circuit unit 100 being damaged by in rush current and to avoid a voltage drop in the power that is being supplied to the second circuit unit 200, the present disclosure controls the first control port to cut off the first connection port and the second connection port, and thus immediately severing an electrical pathway between the first port 101 and the fifth port 301.

To ensure that the isolation switch 30 is indeed functional, i.e. the first control port of the isolation switch 30 can indeed be controlled to cut off the first connection port and the second connection port, the present disclosure uses the electrical detection unit 20 to monitor whether the capacitor 10 is discharging.

When the first control port of the isolation switch 30 can indeed be controlled to cut off the first connection port and the second connection port, since the first circuit unit 100 already stopped supplying power, the capacitor 10 would stop charging and start discharging. The voltage of the power stored in the capacitor 10 would exponentially decay. As such, the processing unit 40 would determine that the voltage signal measured by the electrical detection unit 20 changes in voltage level, thus determining that the capacitor 10 is indeed discharging, and acknowledging that the first control port of the isolation switch 30 can indeed be controlled to cut off the first connection port and the second connection port.

When the first control port of the isolation switch 30 is determined to be abnormal and unable to cut off the first connection port and the second connection port, then the power outputted by the third circuit unit 300 would continuously charge up the capacitor 10, preventing the capacitor 10 from discharging. As such, the processing unit 40 would determine that the voltage signal measured by the electrical detection unit 20 does not change, thus determining that the capacitor 10 is unable to discharge, and acknowledging that the first control port of the isolation switch 30 is abnormal and unable to cut off the first connection port and the second connection port, or simply put, acknowledging that the isolation switch 30 is leaking electricity. As such, during this test phase the user of the present disclosure would be able to replace the faulty isolation switch 30 for a new one, thus allowing actual usage of the isolation switch 30 in future to be free from an electrical leakage caused by the faulty isolation switch 30.

The above example demonstrates that, overall, the present disclosure is able to assist in pre-testing whether the electronic components within the redundant power system are functioning correctly, thereby helping to prevent power supply abnormalities when the redundant power system is put into actual use. In other words, by assisting in a pre-test and discovering an electrical leakage has occurred between the first circuit unit 100 and the second circuit unit 200, the user of the present disclosure may conduct maintenance before actual usage. The present disclosure is able to assist the user in maintaining a system that requires UPS. When in actual usage, since the electronic component has already been tested and maintained, the first circuit unit 100 would be able to successfully hot swapped from the second circuit unit 200 without being damaged by the power supplied by the third circuit unit 300.

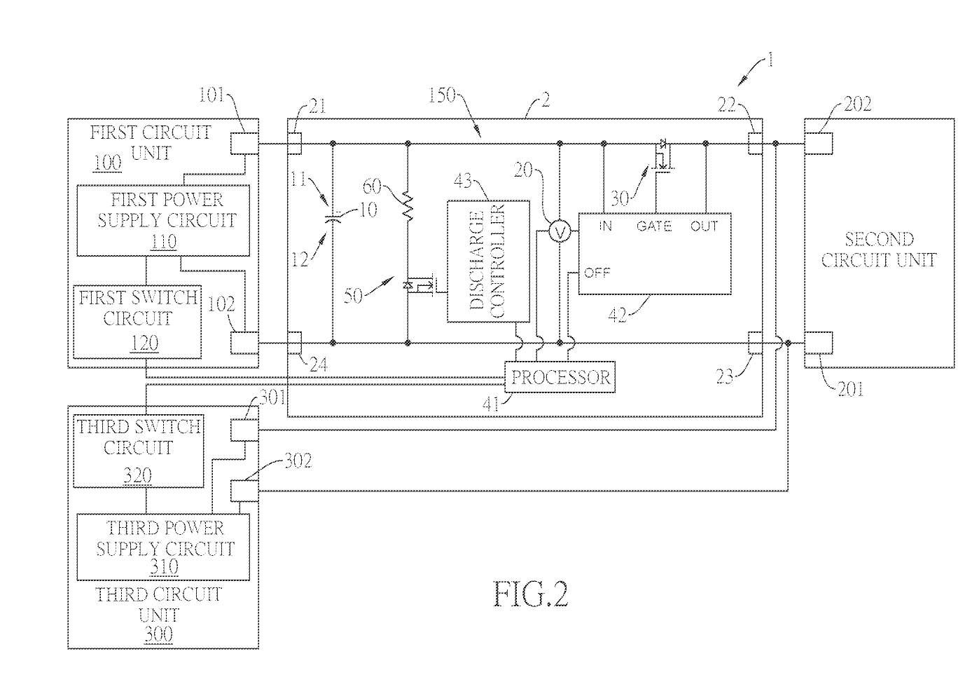

With further reference to FIG. 2, in the first embodiment, a protection circuit 2 of a redundant power system of the present disclosure is installed between the first circuit unit 100 and the second circuit unit 200. The protection circuit 2 includes the electrical detection unit 20, the isolation switch 30, the processing unit 40, the first switch unit 50, and the power loop 150 mentioned before.

In a preferred embodiment, the protection circuit 2 also includes a first protection circuit port 21, a second protection circuit port 22, a third protection circuit port 23, and a fourth protection circuit port 24.

The first protection circuit port 21 is configured to electrically connect to the first port 101 of the first circuit unit 100. The second protection circuit port 22 is configured to electrically connect the fourth port 202 of the second circuit unit 200 and the fifth port 301 of the third circuit unit 300. The third protection circuit port 23 is configured to electrically connect the third port of the second circuit unit 200 and the sixth port 302 of the third circuit unit 300. The fourth protection circuit port 24 is configured to electrically connect the second port 102 of the first circuit unit 100.

Furthermore, the processing unit 40 includes a processor 41, an Oring controller 42, and a discharge controller 43.

The processor 41 is a microcontroller unit (MCU), and the processor 41 uses double-sideband (DSB) to communicate signals to the Oring controller 42, and the discharge controller 43.

In some embodiments, the Oring controller 42 may have a plurality of ports. For example, as shown in FIG. 2, the Oring controller 42 includes an OFF port, an IN port, a GATE port, and an OUT port. The OFF port is electrically connected to the processor 41 for communicating with the processor 41. The IN port is electrically connected to the first connection port of the isolation switch 30. The GATE port is electrically connected to the first control port of the isolation switch 30. The OUT port is electrically connected to the second connection port of the isolation switch 30. As such, the Oring controller 42 is able to detect a voltage difference between the IN port and the OUT port, and according to the command received from the processor 41, adjust a voltage level outputted from the GATE port to the first control port of the isolation switch 30.

Similarly, the discharge controller 43 is electrically connected to the second control port of the first circuit unit 50 and the processor 41, and the discharge controller 43 further adjusts a voltage level outputted to the second control port of the first circuit unit 50 according to the command received from the processor 41.

In the present embodiment, all electronic components installed between the first protection circuit port 21, the second protection circuit port 22, the third protection circuit port 23, and the fourth protection circuit port 24 of the protection circuit 2 are all mounted on a hardware structure, such as on a printed circuit board (PCB), for ease of being carried by the user. The user of the present disclosure may carry the protection circuit 2 to install between a power supply and a load, in other words, to efficiently install the protection circuit 2 between the first circuit unit 100 and the second circuit unit 200. As the first circuit unit 100 and the second circuit unit 200 are efficiently modified to include the portable protection circuit 2, the first circuit unit 100 and the second circuit unit 200 are upgraded to integrate with the protection circuit 2. The protection circuit 2 provides the means to test the electronic components between the first circuit unit 100 and the second circuit unit 200.

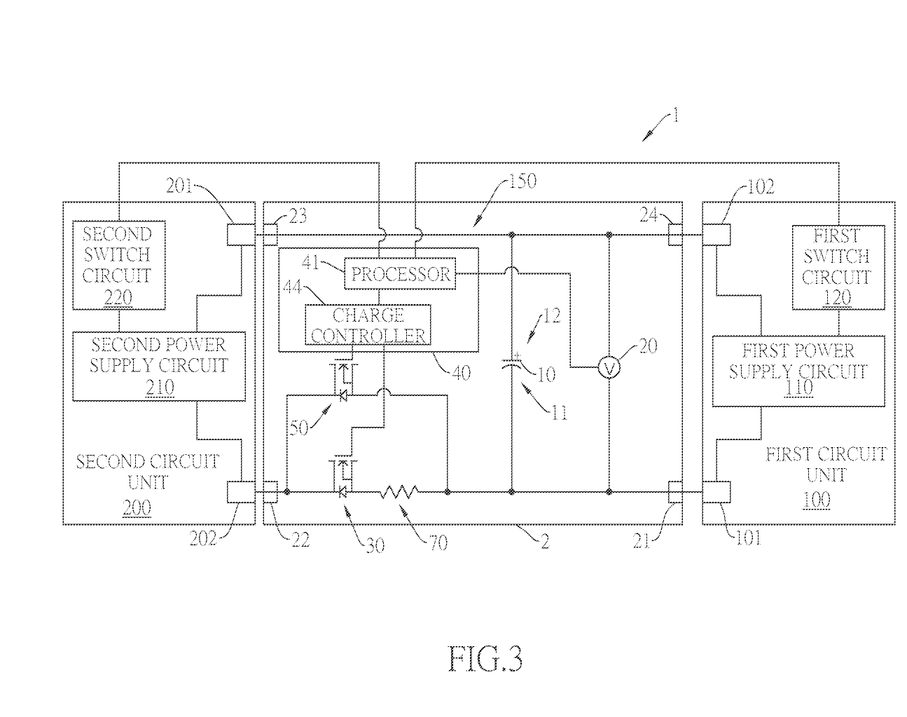

With reference to FIG. 3, the present disclosure may be applied to various applications. In a second embodiment shown in FIG. 3, apart from having the capacitor 10, the electrical detection unit 20, the isolation switch 30, and the processing unit 40, the protection circuit 2 of the redundant power system 1 also includes a first switch unit 50 and a second resistor 70.

In the present embodiment, the isolation switch 30 and the first switch unit 50 are both NMOS. The first circuit unit 100 belongs to a power supply, and the second circuit unit 200 is a power delivery circuit. In terms of usage, the second circuit unit 200 would first provide power to the first circuit unit 100, and when the first circuit unit 100 is fully charged, the first circuit unit 100 would then supply power to the second circuit unit 200. As a result, the first circuit unit 100, which receives power from the third port 201 to the second port 102, normally would not simultaneously output power to the second circuit unit 200. Only when the first circuit unit 100 is fully charged, would the first circuit unit 100 output power from the first port 101 to the fourth port 202 of the second circuit unit 200. Between the first circuit unit 100 and the second circuit unit 200 that exchange power in turns, the present disclosure is able to assist detecting whether the first circuit unit 100 has an abnormal leakage of electricity.

In the present embodiment, the processing unit 40 includes a processor 41 and a charge controller 44. The processor 41 is electrically connected to the first circuit unit 100, the second circuit unit 200, the electrical detection unit 20, and the charge controller 44. The processor 41 is an MCU and controls the first circuit unit 100 and the second circuit unit 200 respectively for dictating when the first circuit unit 100 outputs electricity to the second circuit unit 200 and when the second circuit unit 200 outputs electricity to the first circuit unit 100. The processor 41 also receives the voltage signal that is outputted by the electrical detection unit 20 for detecting the voltage difference between the first side 11 and the second side 12 of the capacitor 10.

More particularly, the first circuit unit 100 includes a first power supply circuit 110 and a first switch circuit 120. The second circuit unit 200 includes a second power supply circuit 210 and a second switch circuit 220.

The first power supply circuit 110 is electrically connected to the first port 101 and the second port 102, and the first switch circuit 120 is electrically connected to the first power supply circuit 110 and the processing unit 40. The second power supply circuit 210 is electrically connected to the third port 201 and the fourth port 202, and the second switch circuit 220 is electrically connected to the second power supply circuit 210 and the processing unit 40.

The charge controller 44 is electrically connected to the processor 41, the first control port of the isolation switch 30, and the second control port of the first switch unit 50. The charge controller 44 receives the command outputted by the processor 41, and accordingly, the charge controller 44 generates and outputs adequate voltage to the first control port of the isolation switch 30 and the second control port of the first switch unit 50. As such, the charge controller 44 controls whether the isolation switch 30 should be turned on to conduct and whether the first switch unit 50 should be turned on to conduct.

In the present disclosure, the second connection port of the isolation switch 30 and the fourth connection port of the first switch unit 50 are respectively electrically connected to the second protection circuit port 22, thus electrically connecting the fourth port 202 of the second circuit unit 200 through the second protection circuit port 22. The second resistor 70 is electrically connecting between the first connection port of the isolation switch 30 and the third connection port of the first switch unit 50. The first connection port of the isolation switch 30 is electrically connected to the first protection circuit port 21, the electrical detection unit 20, the first side 11 of the capacitor 10, and the second resistor 70. The first connection port of the isolation switch 30 electrically connects to the third connection port of the first switch unit 50 through the second resistor 70.

As such, the processor 41 may control the second switch circuit 220 for initiating the second power supply circuit 210 to output electricity from the third port 201 to the second port 102 of the first circuit unit 100. The processor 41 may also control the first switch circuit 120 to prevent the first power supply circuit 110 from outputting electricity from the first port 101 to the fourth port 202 of the second circuit unit 200. As such, by monitoring whether the capacitor 10 is being charged, whether an electrical leakage occurred between the first port 101 and the second port 102 of the first circuit unit 100 may be determined.

More particularly, when the first circuit unit 100 is controlled by the processor 41 to refrain from outputting electricity from the first port 101, normally the first circuit unit 100 would indeed refrain from outputting electricity from the first port 101. However, when the first circuit unit 100 is faulty and abnormal, the first circuit unit would leak electricity from the first port 101 back to the second circuit unit 200.

When the first circuit unit 100 is functioning normally, the capacitor 10 would be charging, and thus the voltage signal measured by the electrical detection unit 20 would change in response to how the voltage across the first side 11 and the second side 12 of the capacitor 10 is increasing. As such, the processor 41 would determine that the voltage signal changes in voltage level, hence the first circuit unit 100 is functioning normally without any electrical leakages across the first port 101 and the second port 102.

When the first circuit unit 100 is faulty, since the capacitor 10 is shorted by an electrical pathway across the first port 101 and the second port 102 of the first circuit unit 100, the capacitor 10 is prevented from charging up. As a result, the processor 41 would determine that the voltage signal does not change, and that the first circuit unit 100 is faulty for leaking electricity across the first port 101 and the second port 102, which shorts the capacitor 10 from receiving electricity. As such, the processor 41 would accordingly generate and output the power supply abnormal signal.

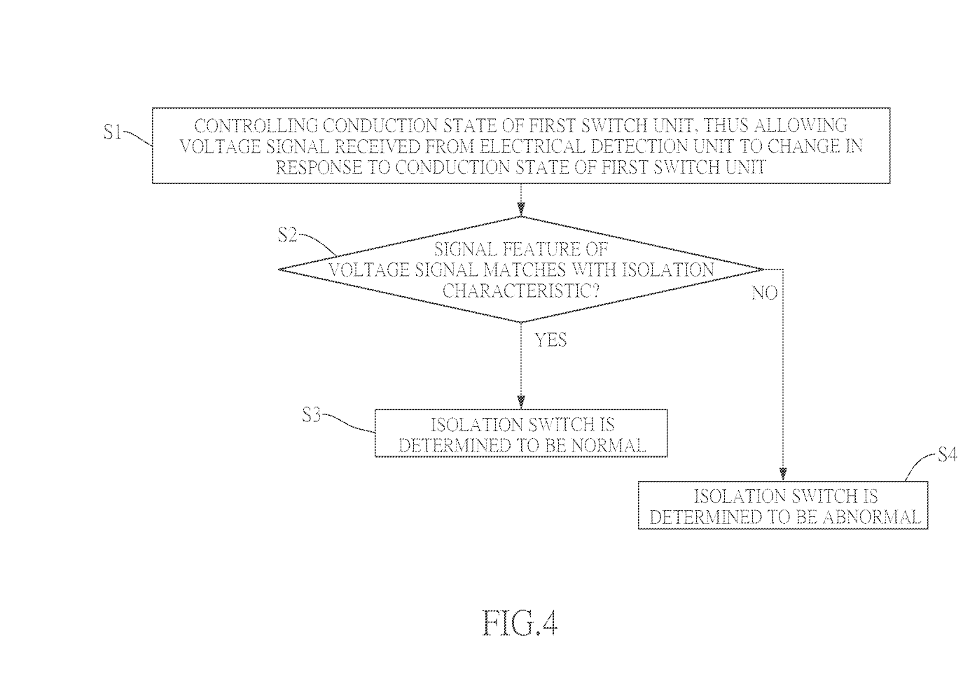

With further reference to FIG. 4, overall, across all embodiments, the processing unit 40 of the present disclosure, or more particularly, the processor 41 within the processing unit 40, executes an error detection method of a redundant power system. The error detection method of the present disclosure is able to help detect whether an electrical leakage occurred between the first circuit unit 100 and the second circuit unit 200. The error detection method of the present disclosure includes the following steps:

step S1: controlling a conduction state of a first switch unit, thus allowing a voltage signal received from an electrical detection unit to change in response to a conduction state of the first switch unit;

step S2: determining whether a signal feature of the voltage signal matches with an isolation characteristic;

step S3: when the signal feature matches with the isolation characteristic, the isolation switch is determined to be normal; and

step S4: when the signal feature mismatches with the isolation characteristic, the isolation switch is determined to be abnormal.

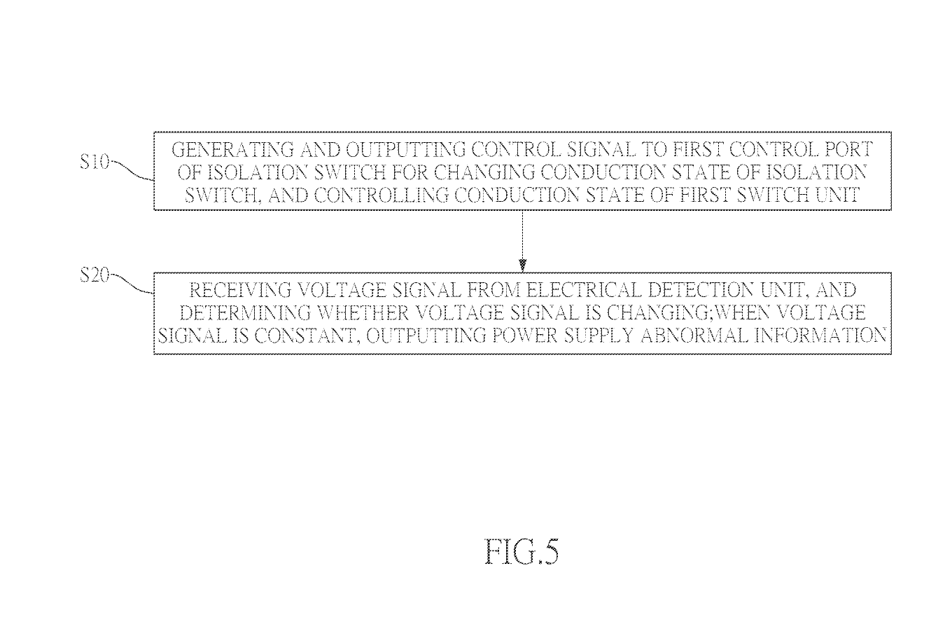

With further reference to FIG. 5, in an embodiment, when the processing unit 40 controls the conduction state of the first switch unit 50, the processing unit 40 generates and outputs a control signal to a first control port of the isolation switch 30, thus turning off the isolation switch 30. Furthermore, when the processing unit 40 determines that the signal feature of the voltage signal matches with the isolation characteristic, the processing unit 40, in short, determines whether the voltage signal is changing. When the processing unit 40 determines that the voltage signal does not change, the processing unit 40 determines that the isolation switch is abnormal and thus generates a power supply abnormal signal. When the processing unit 40 determines that the voltage signal changes, the processing unit 40 determines that the isolation switch is normal and thus refrains from generating the power supply abnormal signal.

In the present embodiment, the error detection method of the present disclosure may be generalized into the following steps:

step S10: generating and outputting a control signal to a first control port of an isolation switch for changing a conduction state of the isolation switch, and controlling a conduction state of the first switch unit; and

step S20: receiving a voltage signal from an electrical detection unit, and determining whether the voltage signal is changing; when the voltage signal is constant (does not change), outputting a power supply abnormal information.

In the embodiment that the processor 41 in the processing unit 40 controls the first circuit unit 100, when the processor 41 executes step S10, the processor 41 simultaneously outputs a first circuit control signal to the first circuit unit 100, for controlling the circuit unit 100 to stop outputting electricity from the first port 101. This creates the situation ideal for detecting the voltage differences across the first side 11 and the second side 12 of the capacitor 10.

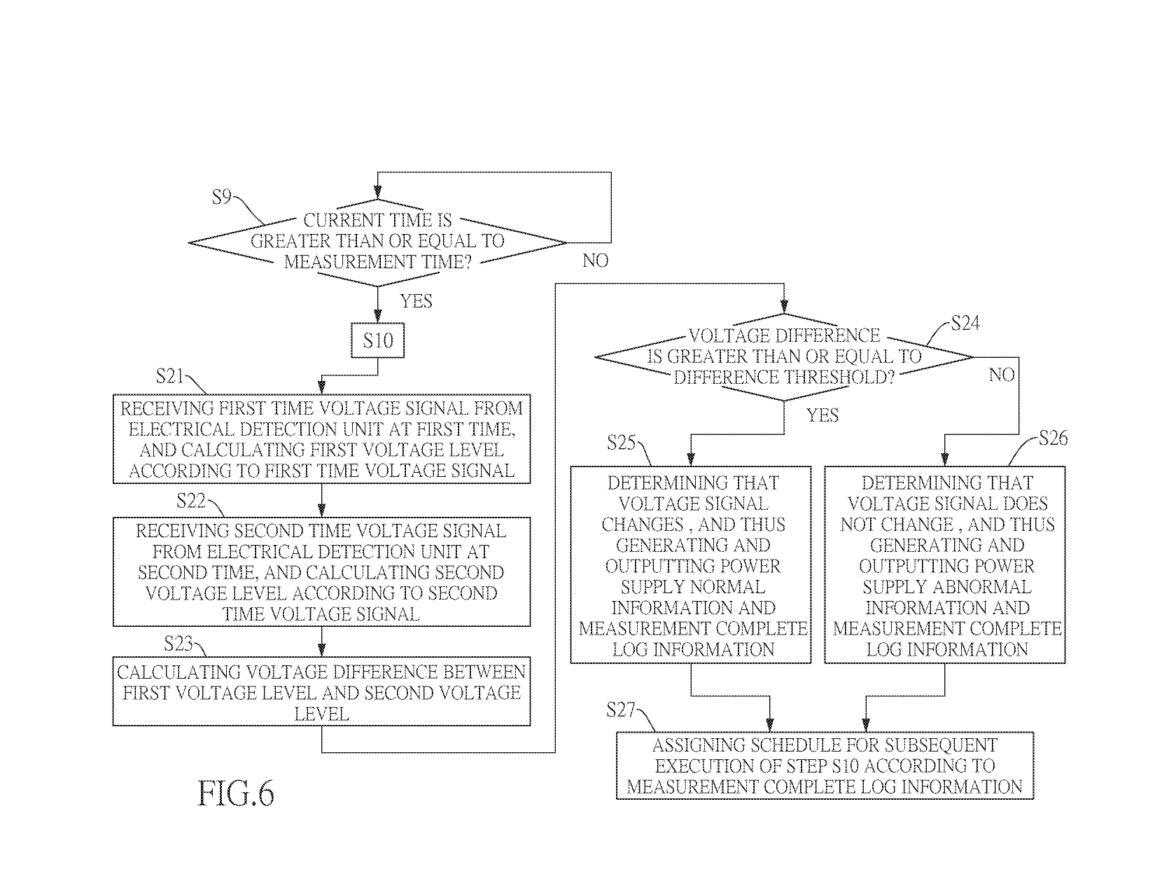

With reference to FIG. 6, in an embodiment, the error detection method includes the following step before step S10:

step S9: determining whether a current time is greater than or equal to a measurement time; when the current time is greater than or equal to the measurement time, executing step S10; when the current time is less than the measurement time, refraining from executing step S10.

In other words, the processor 41 in the processing unit 40 has a timer. The timer periodically checks whether the first circuit unit 100 and the second circuit unit 200 are working normally. When only little time has passed, such that when the current time is less than the measurement time, a test is not required. However, when sufficient time has passed, such that when the current time is greater than or equal to the measurement time, then a test, starting by executing the step S10, is required.

Furthermore, the step S20 includes the following sub-steps:

step S21: receiving a first time voltage signal from the electrical detection unit at a first time, and calculating a first voltage level according to the first time voltage signal;

step S22: receiving a second time voltage signal from the electrical detection unit at a second time, and calculating a second voltage level according to the second time voltage signal; wherein a default measurement time gap separates the first time and the second time;

step S23: calculating a voltage difference between the first voltage level and the second voltage level;

step S24: determining whether the voltage difference is greater than or equal to a difference threshold;

step S25: when the voltage difference is greater than or equal to the difference threshold, determining that the voltage signal changes, and thus generating and outputting a power supply normal information and a measurement complete log information;

step S26: when the voltage difference is less than the difference threshold, determining that the voltage signal does not change, and thus generating and outputting the power supply abnormal information and the measurement complete log information; and

step S27: assigning a schedule for subsequent execution of step S10 according to the measurement complete log information.

In other words, the timer inside of the processor 41 keeps track of the default measurement time gap that separates receiving the first time voltage signal at the first time and receiving the second time voltage signal at the second time. As the capacitor 10 charges and discharges with exponential changes to its voltage levels, by sampling of the capacitor 10 over a sufficient amount of time, such as by keeping track of the capacitor 10 over the default measurement time gap, the voltage difference across the first side 11 and the second side 12 of the capacitor 10 can be more easily observed with more significant changes. Moreover, in order to correctly determine whether the capacitor 10 charges or discharges, the difference threshold is used to judge the voltage difference. When less than the difference threshold, the voltage difference is considered due to a fluctuation in voltage level, and thus the capacitor 10 is considered to be constant without being charged or discharged.

When the present disclosure is applied to a redundant system with multiple power supplies, each of the power supplies may be equipped with a protection circuit 2 of the present disclosure. For example, the first circuit unit 100 is electrically connected to the second circuit unit 100 through one of the protection circuits 2, and the third circuit unit 300 may also be electrically connected to the second circuit unit 200 through another one of the protection circuits 2. When each of the power supplies is connected to the second circuit unit 200 through one of the protection circuits 2, the error detection method of the present disclosure is able to respectively test each of the protection circuits 2, and repeatedly and periodically test through each of the protection circuits 2 in a loop. Every time when one of the protection circuits 2 has completed its test, the error detection method of the present disclosure, by executing step S27, may assign the schedule for testing the next one of the protection circuits 2.

In an embodiment, each of the protection circuits 2 is scheduled to be tested periodically at a given time. For example, according to the current time, such as a time of a system clock, a specified time is scheduled for subsequently executing step S10. In other words, when the current time equals the specified time, the processor 41 subsequently executes step S10.

In another embodiment, each of the protection circuits 2 is timed to be tested periodically. For example, when executing step S27, the timer starts timing when to subsequently execute step S10. In other words, when the timer counts down to zero, the processor 41 subsequently executes step S10.

In another embodiment, each of the protection circuits 2 is scheduled for testing according to whether the measurement complete log information is generated. For example, when one of the protection circuits 2, such as a first protection circuit, completes its testing, the processor 41 of the first protection circuit outputs the measurement complete log information to the processor 41 of another protection circuit 2, such as the processor 41 of a second protection circuit. When the processor 41 of the second protection circuit receives the measurement complete log information from the processor 41 of the first protection circuit, the processor 41 of the second protection circuit 42 only then starts executing step S10. As such, the present disclosure is able to systematically schedule repeated periodic tests to each of the protection circuits 2 that corresponds to each of the power supplies. This allows all of the Oring MOS or all power supplies of the redundant power system to be tested, for whether an error of an electricity leak is present as an abnormality to the redundant power system.

What is claimed is:

1. A redundant power system, comprising:
a first circuit unit;
a second circuit unit, electrically connected to the first circuit unit to form a power loop, wherein the second circuit unit receives a power provided by the first circuit unit via the power loop;
an isolation switch, connected in series with the power loop;
an electrical detection unit, electrically connected to the power loop for detecting an electrical change on the power loop and accordingly outputting a voltage signal;
a first switch unit, connected in parallel with the first circuit unit and the second circuit unit; and
a processing unit, electrically connected to the electrical detection unit and the first switch unit for determining whether the isolation switch is abnormal, wherein:
when the isolation switch is controlled to be turned off, the processing unit controls a conduction state of the first switch unit so that the voltage signal changes in response to a conduction state of the first switch unit;
the processing unit determines whether a signal feature of the voltage signal matches with an isolation characteristic, and when the signal feature mismatches with the isolation characteristic, the isolation switch is determined to be abnormal.

2. The redundant power system as claimed in claim 1, wherein the first circuit unit comprises a first port and a second port, and the second circuit unit comprises a third port and a fourth port; the first port is electrically connected to the fourth port, and the third port is electrically connected to the second port via the power loop;
wherein the redundant power system further comprises:
a capacitor, disposed in the power loop and having a first side and a second side; the first side is opposite to the second side, the first side is electrically connected to the first port and the fourth port, and the second side is electrically connected to the third port and the second port;
wherein the electrical detection unit is electrically connected between the first side and the second side of the capacitor for detecting a voltage difference across the first side and the second side of the capacitor and outputting the voltage signal according to the voltage difference;
wherein the isolation switch comprises a first connection port, a second connection port, and a first control port; wherein the first connection port is electrically connected to the first port of the first circuit unit, and the second connection port is electrically connected to the fourth port of the second circuit unit;
wherein the processing unit is electrically connected to the first control port of the isolation switch and the electrical detection unit, and the processing unit receives the voltage signal outputted by the electrical detection unit;
wherein when the processing unit generates and outputs a control signal to the first control port for changing the conduction state of the isolation switch, the processing unit determines whether the voltage signal changes;
wherein when the processing unit determines that the voltage signal does not change, the processing unit generates and outputs a power supply abnormal signal.

3. The redundant power system as claimed in claim 2, wherein the first circuit unit belongs to a power supply, and the processing unit is electrically connected to the first circuit unit;
wherein when the processing unit generates and outputs the control signal to the first control port for changing the conduction state of the isolation switch, the processing unit further controls the first circuit unit to stop outputting electricity from the first port.

4. The redundant power system as claimed in claim 3, further comprising:
a third circuit unit, comprising a fifth port and a sixth port; wherein the fifth port is electrically connected to the fourth port, and the third port is electrically connected to the sixth port; and
wherein the power loop further comprises:
a first resistor, electrically connected between the first side and the second side of the capacitor;
wherein the third circuit unit belongs to another power supply, the second circuit unit is a load, the isolation switch is a N-type MOSFET (NMOS), the first connection port is a source electrode, the second connection port is a drain electrode, and the first control port is a gate electrode.

5. The redundant power system as claimed in claim 4, wherein the first switch unit comprises a third connection port, a fourth connection port, and a second control port; wherein the third connection port and the fourth connection port are connected in series with the first resistor between the first side and the second side of the capacitor, and the processing unit is electrically connected to the second control port;
wherein before the processing unit generates and outputs the control signal to the first control port for changing the conduction state of the isolation switch, the processing unit first controls the first control port to turn on the first connection port and the second connection port and then controls the second control port to cut off the third connection port and the fourth connection port;
wherein when the processing unit generates and outputs the control signal to the first control port for changing the conduction state of the isolation switch, the processing unit controls the first control port to cut off the first connection port and the second connection port and then controls the second control port to turn on the third connection port and the fourth connection port.

6. The redundant power system as claimed in claim 3, wherein the power loop further comprises:
a second resistor, electrically connected between the first side of the capacitor and the first connection port of the isolation switch;
wherein the second circuit unit is a power delivery circuit, the isolation switch is a N-type MOSFET (NMOS), the first connection port is a source electrode, the second connection port is a drain electrode, and the first control port is a gate electrode.

7. The redundant power system as claimed in claim 6, wherein the first switch unit comprises a third connection port, a fourth connection port, and a second control port; the processing unit is electrically connected to the second control port, the third connection port is electrically connected to the first side of the capacitor, and the fourth connection port is electrically connected to the fourth port of the second circuit unit;
wherein when the processing unit generates and outputs the control signal to the first control port for changing the conduction state of the isolation switch, the processing unit controls the first control port to turn on the first connection port and the second connection port and then controls the second control port to cut off the third connection port and the fourth connection port.

8. A protection circuit of a redundant power system, comprising:
a power loop, configured to electrically connect a first circuit unit and a second circuit unit, wherein the second circuit unit receives a power provided by the first circuit unit via the power loop;
an isolation switch, connected in series with the power loop;
an electrical detection unit, electrically connected to the power loop for detecting an electrical change on the power loop and accordingly outputting a voltage signal;
a first switch unit, connected in parallel with the first circuit unit and the second circuit unit; and
a processing unit, electrically connected to the electrical detection unit and the first switch unit for determining whether the isolation switch is abnormal, wherein:
when the isolation switch is controlled to be turned off, the processing unit controls a conduction state of the first switch unit, thus allowing the voltage signal to change in response to a conduction state of the first switch unit;
the processing unit determines whether a signal feature of the voltage signal matches with an isolation characteristic, and when the signal feature mismatches with the isolation characteristic, the isolation switch is determined to be abnormal.

9. The protection circuit as claimed in claim 8, further comprising:
a first protection circuit port, configured to electrically connect a first port of a first circuit unit;
a second protection circuit port, configured to electrically connect a fourth port of a second circuit unit;
a third protection circuit port, configured to electrically connect a third port of the second circuit unit;
a fourth protection circuit port, configured to electrically connect a second port of the first circuit unit;
a capacitor, comprising a first side and a second side; wherein the first side is opposite to the second side, the first side is electrically connected to the first protection circuit port and the second protection circuit port, and the second side is electrically connected to the third protection circuit port and the fourth protection circuit port; and
an electrical detection unit, electrically connected between the first side and the second side of the capacitor for determining a voltage difference across the first side and the second side of the capacitor, and outputting the voltage signal according to the voltage difference;
wherein the isolation switch comprises a first connection port, a second connection port, and a first control port; wherein the first connection port is electrically connected to the first protection circuit port, and the second connection port is electrically connected to the second protection circuit port;
wherein the processing unit is electrically connected to the first control port of the isolation switch, and the processing unit receives the voltage signal outputted by the electrical detection unit;
wherein when the processing unit generates and outputs a control signal to the first control port for changing the conduction state of the isolation switch, the processing unit determines whether the voltage signal is changing;
wherein when the processing unit determines that the voltage signal does not change, the processing unit generates and outputs a power supply abnormal signal.

10. The protection circuit as claimed in claim 9, wherein the processing unit is configured to electrically connect to the first circuit unit, and the first circuit unit belongs to a power supply;
wherein when the processing unit generates and outputs the control signal to the first control port for changing the conduction state of the isolation switch, the processing unit further controls the first circuit unit to stop outputting electricity from the first port.

11. The protection circuit as claimed in claim 10, further comprising:
a first resistor, electrically connected between the first side and the second side of the capacitor;
wherein the second protection circuit port is configured to electrically connected to a fifth port of a third circuit unit, the third protection circuit port is configured to electrically connect to a sixth port of the third circuit unit, and the third circuit unit belongs to another power supply;
wherein the second circuit unit is a load, the isolation switch is a N-type MOSFET (NMOS), the first connection port is a source electrode, the second connection port is a drain electrode, and the first control port is a gate electrode.

12. The protection circuit as claimed in claim 11, wherein the first switch unit comprises a third connection port, a fourth connection port, and a second control port; wherein the third connection port and the fourth connection port are connected in series with the first resistor between the first side and the second side of the capacitor, and the processing unit is electrically connected to the second control port;
wherein before the processing unit generates and outputs the control signal to the first control port for changing the conduction state of the isolation switch, the processing unit first controls the first control port to turn on the first connection port and the second connection port and then controls the second control port to cut off the third connection port and the fourth connection port;
wherein when the processing unit generates and outputs the control signal to the first control port for changing the conduction state of the isolation switch, the processing unit controls the first control port to cut off the first connection port and the second connection port and then controls the second control port to turn on the third connection port and the fourth connection port.

13. The protection circuit as claimed in claim 10, further comprising:
a second resistor, electrically connected between the first side of the capacitor and the first connection port of the isolation switch;
wherein the second circuit unit is a power delivery circuit, the isolation switch is a N-type MOSFET (NMOS), the first connection port is a source electrode, the second connection port is a drain electrode, and the first control port is a gate electrode.

14. The protection circuit as claimed in claim 13, wherein the first switch unit comprises a third connection port, a fourth connection port, and a second control port; the processing unit is electrically connected to the second control port, the third connection port is electrically connected to the first side of the capacitor, and the fourth connection port is electrically connected to the fourth port of the second circuit unit;
wherein when the processing unit generates and outputs the control signal to the first control port for changing the conduction state of the isolation switch, the processing unit controls the first control port to turn on the first connection port and the second connection port and then controls the second control port to cut off the third connection port and the fourth connection port.

15. An error detection method of a redundant power system, executed by a processing unit of the redundant power system as claimed in claim 1, comprising the following steps:
controlling a conduction state of a first switch unit, and thus allowing a voltage signal received from an electrical detection unit to change in response to a conduction state of the first switch unit;
determining whether a signal feature of the voltage signal matches with an isolation characteristic; and
when the signal feature mismatches with the isolation characteristic, the isolation switch is determined to be abnormal.

16. The error detection method as claimed in claim 15, wherein when the processing unit controls the conduction state of the first switch unit, the processing unit generates and outputs a control signal to a first control port of the isolation switch to cut off a first connection port and a second connection port of the isolation switch;
wherein when the processing unit determines whether the signal feature of the voltage signal matches with the isolation characteristic, the processing unit determines whether the voltage signal is changing;
when the voltage signal does not change, the isolation switch is determined to be abnormal and thus the processing unit generates and outputs a power supply abnormal signal.

17. The error detection method as claimed in claim 16, wherein when the processing unit outputs the control signal to the first control port of the isolation switch, the processing unit further outputs a first circuit control signal to a first circuit unit for controlling the first circuit unit to stop outputting electricity from a first port.

18. The error detection method as claimed in claim 16, wherein to receive the voltage signal received from the electrical detection unit, and to determine whether the voltage signal is changing, is a step that comprises the following sub-steps:
receiving a first time voltage signal from the electrical detection unit at a first time, and calculating a first voltage level according to the first time voltage signal;
receiving a second time voltage signal from the electrical detection unit at a second time, and calculating a second voltage level according to the second time voltage signal; wherein a default measurement time gap separates the first time and the second time;
calculating a voltage difference between the first voltage level and the second voltage level;
determining whether the voltage difference is greater than or equal to a difference threshold;
when the voltage difference is greater than or equal to the difference threshold, determining that the voltage signal changes;
when the voltage difference is less than the difference threshold, determining that the voltage signal does not change.

19. The error detection method as claimed in claim 16, wherein before the processing unit outputs the control signal to the first control port of the isolation switch, the error detection method comprises the following steps:
determining whether a current time is greater than or equal to a measurement time;
when the current time is greater than or equal to the measurement time, outputting the control signal to the first control port of the isolation switch;
when the current time is less than the measurement time, refraining from outputting the control signal to the first control port of the isolation switch.

20. The error detection method as claimed in claim 16, further comprising the following steps:
when determining that the voltage signal changes, generating and outputting a power supply normal information;
regardless whether the voltage signal changes, generating a measurement complete log information, and assigning a schedule for subsequently outputting the control signal to the first control port of the isolation switch.
